(19) United States
(12) Patent Application Publication
(10) Pub. No.: US 2002/0105533 A1
(43) Pub. Date: Aug. 8, 2002

(54) Personal virtual 3-D habitat monosphere with assistant

(76) Inventor: Constantine Gus Cristo, Valley Center, CA (US)

Correspondence Address: David Dingeman, 550 Trees Drive, Cedar Hill, TX, 75104, US

(21) Appl. No.: 09/776,961

(22) Filed: Feb. 5, 2001

(51) Int. Cl. G06F 3/00

(52) U.S. Cl. 345/706; 345/850

(57) ABSTRACT

A three dimensional graphical user interface with a single or plurality of expert assistants who aid a user in obtaining, filtering, sorting and utilizing information on both a local client database and information on the World Wide Web.

### BACKGROUND OF THE INVENTION

1. Technical Field of the Invention

This invention relates to an adaptive, three dimensional, graphical user interface with a single or plurality of expert angels, agents or assistants and more particularly, to a method and system of obtaining, filtering, sorting and utilizing information on both a local client database and on the World Wide Web in a 3-D user environment for the purpose of assisting a user in accessing and acting on information by means of a computer, cell phone, wireless hand-held computer or other electronic communication device. The present invention eliminates the need for traditional browsers such as Internet Explorer 5.0 or Netscape 4.7 because the user's assistant(s) browses the web for the user based on the user's input or encrypted personal profile.

2. Description of Related Art

Existing Internet browsers utilize standard Microsoft Window's Internet Explorer or AOL/Netscape browser technology to search the World Wide Web, to chat electronically and to perform other common computer tasks such as finding information and sending e-mail. The user in the prior art opens the computer browser application on a personal computer client and utilizes drop down menus to perform tasks. Consequently, the user is confined to a two-dimensional world on the computer and World Wide Web (Web). However, there are disadvantages to this two-dimensional, traditional manner of “surfing” the web, obtaining information and conducting transactions. First, a two-dimensional browser does not allow the user to select an environment in which that user is familiar with; i.e., Internet browsers only display a command, menu-driven structure and a two-dimensional view of a targeted web site and second, the user does not have any assistance in searching for and filtering data. Third, the traditional browser does not actively operate an assistant who may conduct searches and queries without user interaction. This invention overcomes these limitations by introducing a three-dimensional environment and a personal assistant chosen by the user and filtering technology along with encrypted preferences to enhance the Web browsing experience.

Although there are no known prior art teachings of a solution to the aforementioned deficiency and shortcoming such as that which is disclosed herein, U.S. Pat. No. 5,835,094 ('094) discloses a method for displaying information about computer files to a user on a display in an environment simulating three dimensional space includes displaying a category of files as a container having a size related to its distance from a predefined portion of the display. '094 discloses a three dimensional software application that allows the user to view files as graphical containers with the visual size determined by the size of the file. '094 only addresses the viewing of computer files in a three dimensional viewer and does not teach a method for actively searching for and filtering any information on the Web with the aid of a cyberspace personal assistant.

U.S. Pat. No. 5,896,133 ('133) discloses a graphical navigation user interface for enabling user control of a computer system which may incorporate navigation levels. Each navigation level is based on a physical real world metaphor. The navigation system includes a three or four levels: a individual object level, a room level, a room level, a building level, and a town level. An individual object level is the lowest navigation level and corresponds to specific function. The room level provides a user with options of specific functions. The building level includes a hallway metaphor where the user has options of choosing room objects through a doorway. The town level provides the user with options of choosing various building objects connected by a street metaphor. However, '133 addresses only the three dimensional user interface using metaphors and does teach or suggest a system or method of utilizing a computer generated, personal assistant to obtain information by viewing and interacting with various objects in the three dimensional environment.

U.S. Pat. No. 5,727,174 ('174) discloses a graphical user interface for a computer system that includes one or more intelligent assistants. The interface includes composite icons comprising a graphical representation of a human figure, a representation of a desk, and a mini-icon that associates an assistant with the object it supports. The assistant's desk can be opened to show its contents and the human figure can move from its position next to the desk to a position on the computer display screen next to a suggestions dialog box that displays suggested actions to the user. '174 discloses the notion of an assistant and an object oriented environment; however, it does not address the notion of an agent guiding the user through the virtual world based on stored, encrypted, personal preferences based on the context of the user's actions in the user-selected, three dimensional environment.

U.S. Pat. No. 5,877,759 ('759) discloses a user interface, for example for Internet and intranet agents, embodies the technical potential of automation and delegation into a cohesive structure. The invention also provides intelligent assistance to the client user interface and provides an interface that is centered on autonomous processing of whole tasks rather than sequences of commands, as well as the autonomous detection of contexts which require the launch of a process, especially where such context is time-based.

However, '759 addresses only the use of a non-obtrusive internet assistant in a two-dimensional graphical user interface environment. '759 does not contemplate the learning and storing of the user's encrypted preferences; a three-dimensional virtual environment selection, choice of a three dimensional assistant, nor the key component that the assistant continuously monitors all incoming events such as e-mails, chat friends, upcoming events and any other events or information that the user has stored in his or her local profile. In addition, the '759 assistant only contemplates performing whole tasks while the present invention discloses a method of a multi-tasking, personal assistant who not only retrieves and filters information that the user may have specifically searched for in the three dimensional environment but also information that the user has stored in the local preferences file which is built based on history and user inputs. Another significant advantage of the present invention over '759 is the three dimensional environment of browsing the Web without the aid or distraction of traditional, two-dimensional menu structures.

### SUMMARY OF THE INVENTION

In one aspect, the present invention is a method of obtaining, filtering, sorting and utilizing information on a local database and the World Wide Web by means of a computer, cell phone, wireless hand-held computer, or other device. The method includes the steps of entering a virtual three-dimensional environment by means of personal computer or connecting to the Web by other means, interacting with a single or plurality of expert angels, agents or assistants for the purpose of taking action, gathering information, or making transactions. The agent(s) guide the user through the virtual world based on stored personal preferences of the user and based on the context of the user's actions in the 3-D monosphere.

The expert agent(s) is utilized to obtain information from any available digital source, filtering this data based on the encrypted user preferences, storing this data on the local database and retrieving the data at the user's request or by utilizing an expert system to predict the user's needs. The personal assistant(s) may reside in a duplicate form on a server so that it may continue to seek data for the user. The assistant(s) may also reside on the server for the purpose of the user to be able to contact the assistant by non-networked means such as a cell phone, palm pilot or from another computer. A user enters a 3-D virtual monosphere of their choice, where monosphere is defined as a three-dimensional, virtual environment. The monosphere would be selected by the user and may be any familiar or unfamiliar environment such as a house, castle, city or room. The user may design or alter the appearance of the environment at any time. In addition, a plurality of environments will be available on the Web.

The user is alerted by the virtual, expert agent(s) who resides in the virtual world on the client computer as well as on a plurality of servers on the Internet. The assistant may be a single or multiple form of the user's choice and each agent may take on specific tasks such as notifying the user of any incoming mail, action items, calendar entries or gathering any other information that the user may specify in their personal profile. A financial agent, for example, may be selected to guide the user through investment portfolios and on-line banking. A movie agent may notify the user of new movie releases based on a user input query or user's preferences stored in a personal profile. It is indeterminable how many forms and functions the assistant(s) may take.

The personal profile is utilized by a part of the system and method and contains proprietary, personal data that is used by the virtual agent(s) to find information for the user. The user is also guided through this 3-D virtual world with the assistance of the agent(s) and the user begins to make selections on topics that are of interest or require action. The user may also allow another's assistant(s) to appear in the user's monosphere for the purpose of interacting, chatting, exchanging data or making transactions. In addition, the user's assistant and the visitor's assistant may interact without guidance from the user or the visitor(s). The assistant(s) may decide who has access to the user's monosphere, what business transactions may occur and what data is exchanged all without interfacing with the user.

The method also includes a means of focusing or blurring objects or features in the 3-D virtual monosphere. If the user focuses on an object an event is triggered which may be a user query or the playing, listening or viewing of the object which may be data acquired from a local user database or any other data source on the World Wide Web. The user also may blur the object which results in the event of not focusing on the object and no longer retrieving data that no longer interests the user. The user has many other options which trigger events in the 3-D virtual monosphere such as selecting, using, dropping, and interacting with a plurality of objects such as audio, video, e-mail or other data. Many predefined functions also exist in the monosphere which the user can trigger by means of his computer, cell phone or palm pilot such as playing sound, playing video, displaying text, retrieving a web address, displaying help and displaying images.

In another aspect, the present invention is a system accessing and utilizing a local or non-local database, a speech synthesis engine, a 3-D game engine, agent system technology, expert system logic and artificial intelligence. The user interacts with the 3-D virtual environment when entering the monosphere to check for new objects and proceeds through the environment for the purpose of interacting with the objects as described above. If new objects, such as e-mail or results from previous query or queries are present, the expert angel(s) or assistant(s) notify the user of the new objects. The objects are then played for the user in audio, video, or textual format.

The user may interact with the 3-D virtual monosphere by means of a mouse, keyboard, joystick or other interactive device to access local or non-local databases, the speech synthesis engine, the 3-D game engine, the agent, the expert artificial intelligence system and any other objects for the purpose of efficiently retrieving data that interests the user. The user profile is maintained locally or non-locally in an encrypted form. The profile aids the agent(s) in retrieving, filtering, sorting and displaying objects for the benefit of the user.

In another aspect, the present invention is a system for a computer program which creates a three-dimensional monosphere based on user input or preferences; an assistant(s) selected by the user; a depiction of web sites in the monosphere; the ability to focus and blur to select objects in the monosphere; and a system of storing user preferences.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a simplified block diagram illustrating the components of a client/server information system utilizing a traditional, two-dimensional Internet browser.

FIG. 2 (Prior Art) is a block schematic illustrating a client/server information system utilizing search logic and an Internet agent.

FIG. 3 is a block schematic illustrating a client/server information system utilizing a 3-D virtual monosphere—browser environment with attendant agents which access information on the Internet based on learned preferences or user input queries.

FIG. 4 is a detailed flow chart illustrating the primary logic the system follows when a user opens the 3-D virtual monosphere on any computer device.

### DETAILED DESCRIPTION OF EMBODIMENTS

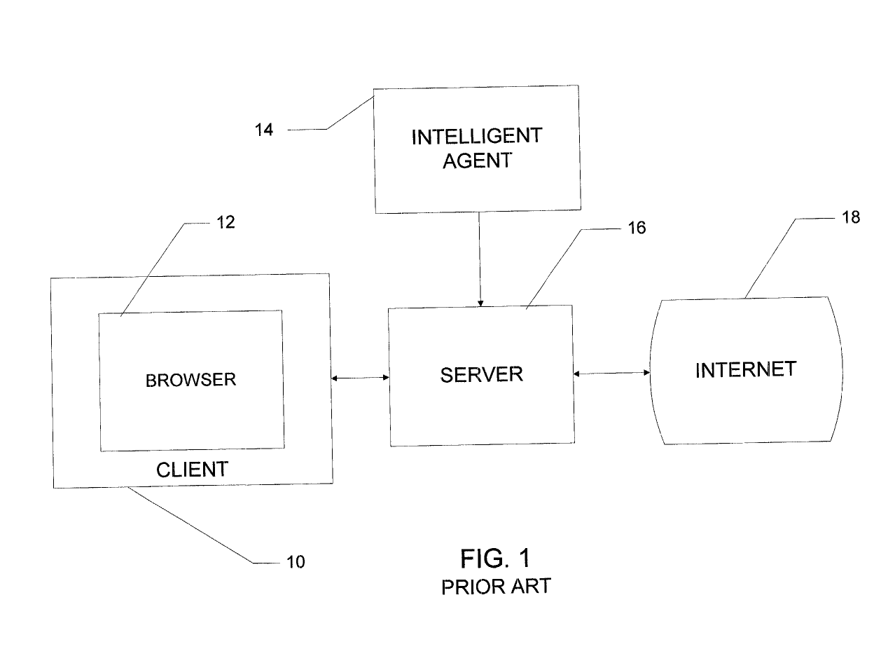

FIG. 1 (Prior Art) is a simplified block diagram illustrating the components of a client/server information system utilizing an Internet browser. In FIG. 1, a user attends his or her personal computer, the client 10, and opens a traditional web browser 12. The user inputs a web address in the menu bar of the browser or selects a command by utilizing the menu structure of the browser, for example, entering a search query to find airline tickets. This search command by means of the client software sends a request to the host server 16 which transmits the request to numerous web sites on the Internet 18. An intelligent agent 14 may be utilized to offer help based strictly on queries input by the user, for example, inputting a query to search by lowest fare. Intelligent agent 14 is limited by the instructions of the user in the present session.

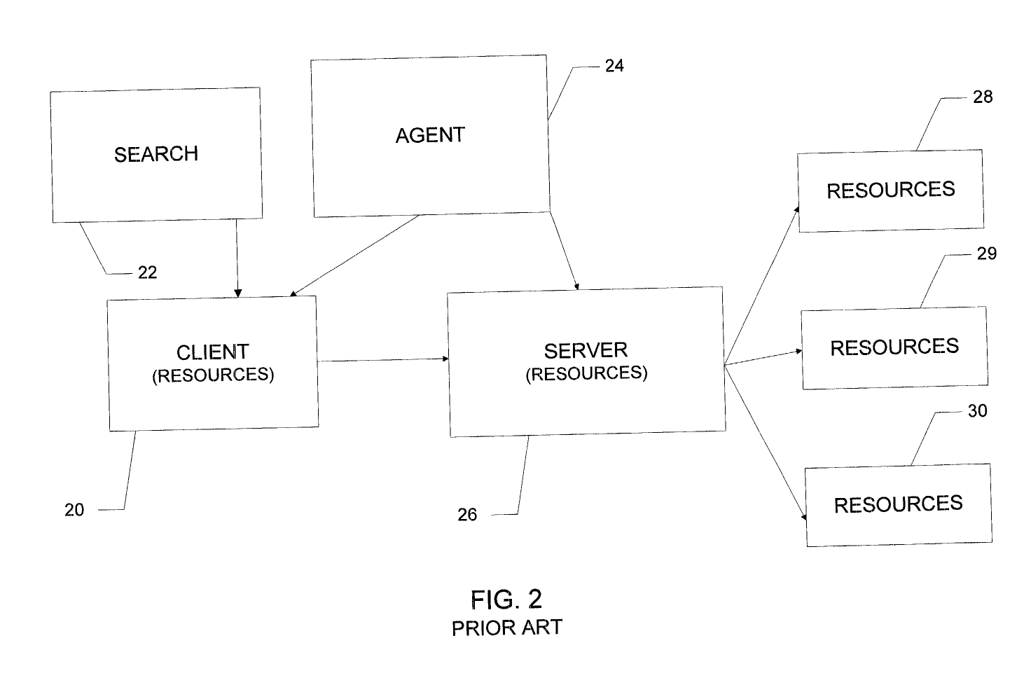

FIG. 2 (Prior Art) is a block schematic illustrating a client/server information system utilizing search logic and an Internet agent. In the prior art, client 20 opens a traditional browser and initiates a search 22. The search request is delegated to any available resource such as local agents 24 who may conduct specific transactions in there entirety. The agent, following the instructions of the client, may send a request or transaction to a server 26 to initiate and complete the request. The server, by means of the Internet, may further transmit the request to any other resources 28-30 to complete the request. The prior art is limited by not storing encrypted preferences or tasks that the user commonly performs and does not allow the user, by means of his agent, to virtually traverse a three-dimensional monosphere to initiate requests.

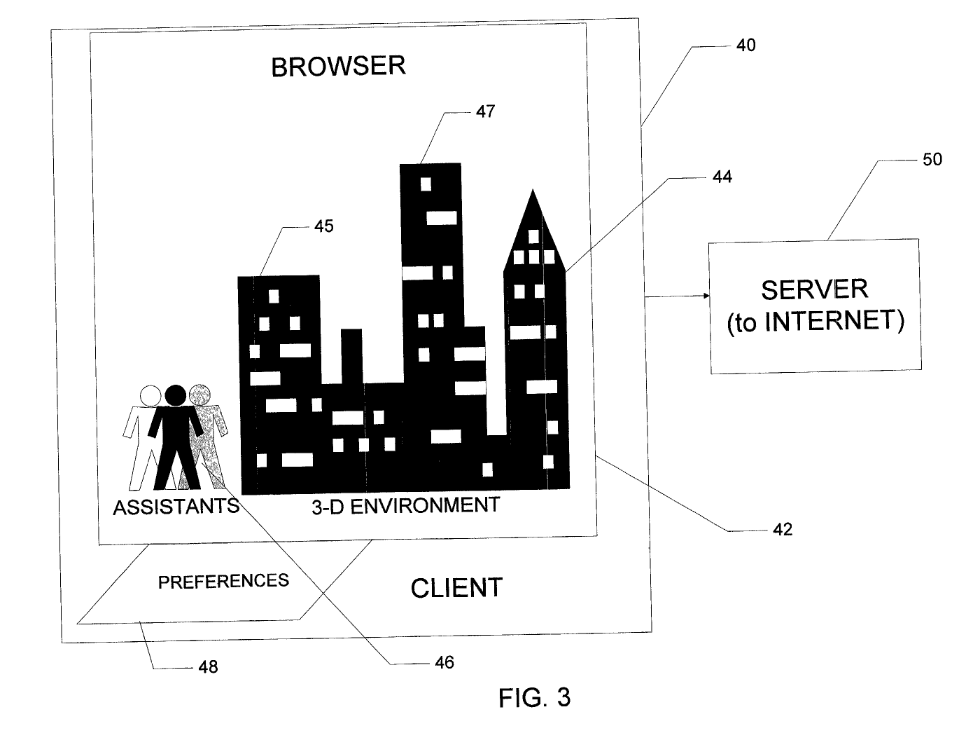

FIG. 3 is a block schematic of the present invention illustrating a client/server information system utilizing a 3-D virtual monosphere—browser environment with attendant agents who access information on the Internet based on learned preferences or user inputs.

The method and system of the present invention is made up of a client 40 who may be using any electronic portal, such as a personal computer, cell phone, wireless hand-held device or web television device. The user initiates communication to the World Wide Web by opening up the browser 42. In computer devices that can portray a three-dimensional environment, the browser will appear as a user specified monosphere such as city 44. The city depicted is merely an example because the user may select a room, a house, a boat, a cave, a castle or any other environment they so choose. Various objects in the monosphere appear based on the user's input and preferences. For example, object 45 may represent movie theaters and object 47 may represent the user's bank. The user, by interacting with the electronic device, may focus on the particular object that he or she is interested in to conduct a query or view the results of a previous search. For example, the user may use any input means interacting with the client to focus in on an object to inquire about a previous transaction or initiate a new search. For example, the user, by manipulating the personal agents 48, may instruct one agent to enter the movie theater to inquire about that evening's show times. Once the user has obtained the information or while the agent is conducting the search, the user may instruct another agent by blurring the present object and focussing on another object to initiate a new transaction. For example, the user may instruct the second agent to enter the bank to complete an electronic transfer. Based on information stored in the user preferences 48, the agent already knows which bank, the account number and other personal information to complete the transaction. While the user merely manipulates the attendant agents in the three dimensional monosphere environment; these agents are actually submitting requests to a server and ultimately the Internet 50 to complete the transaction or request.

The preferred embodiment of the invention suggests a three dimensional graphical user interface with a selected assistant who conducts transactions of its own accord; and receives requests from the user to initiate new searches. The assistant then filters and downloads these objects which could be sound files, information, articles, e-mail messages, bank transactions, chat or other common Web events for the user.

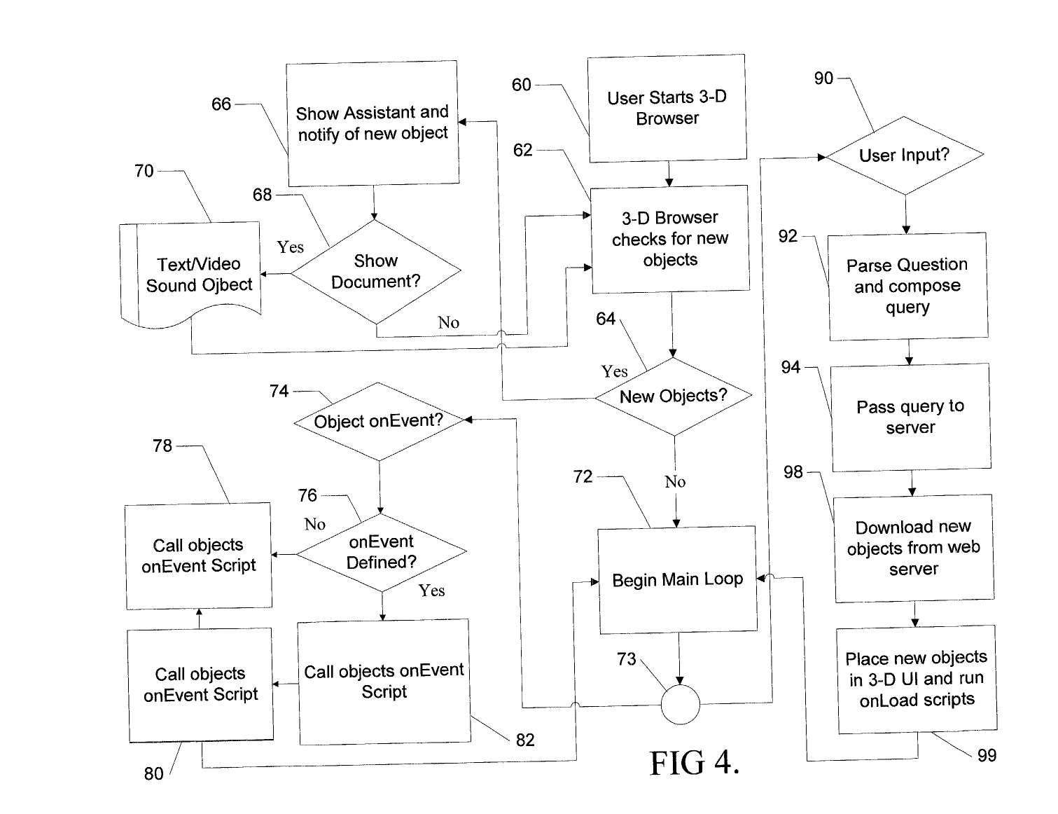

FIG. 4. is a flow chart illustrating the components of the method and system of a user entering a 3-D virtual monosphere and interacting with objects with the aid of an expert angel(s), agent(s) or assistant(s). In FIG. 4, a user enters or starts the 3-D virtual monosphere environment 60 which may be but is not limited to a depiction of a house, castle, city, boat or room. The monosphere may be designed or altered by the user. In addition, a repository of monospheres may be available on the World Wide Web. The user may also enter the system by means of a cell phone, wireless computer, or other electronic device. The user proceeds in the system and method to 62 where the user is informed of new objects such as e-mail messages, instant messages, completed transactions, results from previous user queries or objects found by the assistant(s) based on an encrypted user profile. A plurality of additional assistants may notify the user of items of interest to the user such as recent banking transactions, new movie releases, and maintenance schedules.

At 64, it is determined whether new objects exist. If new objects exist an assistant(s) appears at 66 and notifies the user of the new objects. At 68, it is determined whether to show the new objects based on a query submitted to the user or based on an encrypted profile of the user. If it is determined that new objects should be displayed, the system calls the appropriate viewer or plug-in required by the object. For example, the object may be a new video that the user described in the personal profile. This video file would be played by the appropriate viewer. If it is determined that the new objects should not be presented to the user, the process returns to step 62 to determine whether any other new objects have arrived in the interim. Examples of objects include data, e-mails, and other user's expert assistant(s). The process may also skip the determination of new objects and proceed through step 64 to begin a new query at 72 and initiates the main loop.

If it is determined that there are no new objects, the process begins the main loop 72. The user may immediately terminate the system and method by exiting the 3-D virtual monosphere, hanging up his cell phone or turning off his palm pilot at 73.

However, the user may proceed to behave in such a way that events are triggered which are defined as onEvent 74. onEvent may be an event that is focus, blur, select, use or drop. Focusing is achieved by a click on an object in the 3-D monosphere to read, learn or interact more with that object. For example, if it is determined that the user triggered an event at 74, the process proceeds to 76. At 76, it is determined whether the triggered event has certain defaults or whether the system will call a script to define the event. If the triggered event is a default, the process continues to execute the default script at 78. The process proceeds to 80 to load a new object by means of an onLoad script. At 76, if it is determined that a triggered event does not have a default, the process calls the onEvent script at 82. After execution of this script, the process proceeds to 80 to load the object.

The process returns to the main loop 72. At 72, a user may proceed to step 90 where it is determined whether the user entered new input by means of a keyboard, joystick or other device such as a cell phone or palm pilot. If no input was entered the process returns to 72 and begins the main loop again or proceeds to step 73 and terminates.

At 90, if it is determined that input was entered, the process proceeds to step 92 and the system parses the question and composes a query. Once a query is composed, the process continues to step 94 and passes the query to a web, Internet or Intranet server. At 98, the results of the query are obtained and these new resulting objects are downloaded from the server. At 99, the new objects are placed in the 3-D virtual environment and are processed by the onLoad scripts for access and interaction by the user. The process returns to 72 and begins the main loop again or proceeds to step 73 and terminates.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed:

1. A three-dimensional graphical user interface with active user/agent interaction on a personal computer or server comprising:
a three-dimensional browser that displays data and objects in an environment selected by the user;
representation of said user by an assistant or agent of the user's choice who resides on said local client;
said assistant or agent initiates a transaction, search or query through means of a client connected to the Internet;
said assistant may reside on said servers or interact in third party client devices;
said data represented by actual objects in said three-dimensional graphical user interface.

2. The interface of claim 1 where said user traverses through said three-dimensional environment to focus and blur upon objects to initiate a search, query, filter, retrieval, sorting, displaying, playing or viewing of said objects.

3. The interface of claim one where said user may input instructions to said assistant by means of keyboard, joystick, mouse, voice, or touch.

4. The interface of claim 1 further comprising of an encrypted preferences file stored on local client or server which retains information input by user or learned through said initiated queries.

5. The interface of claim 1, wherein, a user may interact with said environment and said assistant by means of a cell phone, wireless hand-held computer or other Web access device.

6. The interface of claim 1 further comprising of a method of browsing the Internet by means of a three-dimensional environment where data appears as objects and said user interacts with objects through manipulation of said assistant.

7. The method of claim 1 where an assistant or agent assists user in conducting searches, queries and transactions.

8. A method of obtaining, filtering, sorting and utilizing information on both a local client database and information on the World Wide Web in a three-dimensional, graphical user environment by means of a computer, cell phone, hand-held computer or other electronic communication device.

9. The method of claim 8 further comprising of a three dimensional graphical user interface where objects in the environment depict actual data and information.

10. The method of claim 8 further comprising of an assistant or agent who navigates through the three dimensional environment to initiate searches, filter information, and analyze new objects.

11. The method of claim 8 further comprising of personal preferences stored in a secure, encrypted manner to initiate searches and queries without direction from user.

12. A method of obtaining information from any available digital source, filtering this data based on the encrypted user preferences, storing this data on the local database and retrieving the data at the user's request or by utilizing an expert assistant to predict the user's needs.

13. The method of claim 12 further comprising of a three dimensional graphical user interface.

14. The method of claim 12 further comprising of a computer generated assistant who launches, filters, sorts, downloads and loads events or receives instructions from a user.

15. The method of claim 12 further comprising of a method of said three-dimensional assistant traversing through a three dimensional graphical user interface to focus or blur on objects as a means of selecting or not selecting objects to load and run.
